(19) United States
(12) Patent Application Publication
(10) Pub. No.: US 2012/0089472 A1
(43) Pub. Date: Apr. 12, 2012

(54) METHOD FOR VEHICLE ACQUISITION AND EXCHANGE

(75) Inventor: James Scapa, West Bloomfield, MI (US)

(73) Assignee: ALTAIR ENGINEERING, INC., Troy, MI (US)

(21) Appl. No.: 13/253,610

(22) Filed: Oct. 5, 2011

Related U.S. Application Data
(60) Provisional application No. 61/390,317, filed on Oct. 6, 2010.

(51) Int. Cl. G06Q 30/06

(52) U.S. Cl. 705/26.1

(57) ABSTRACT

Disclosed herein is a method of vehicle acquisition and exchange. The method includes assigning a predetermined number of units for a first vehicle and a predetermined number of units for a second vehicle, providing at least one customer with a customer unit pool representing an amount of available product units, receiving a first request from the at least one customer for the first vehicle, determining whether to approve the first request based upon the at least one customer's customer unit pool and the predetermined number of units for the first vehicle using a processor; and if the first request is approved: receiving a second request from the at least one customer to exchange the first vehicle for the second vehicle and determining whether to approve the second request based upon the at least one customer's customer unit pool and the predetermined number of units for the second vehicle.

### CROSS REFERENCE TO RELATED APPLICATION

This Application claims priority to U.S. Provisional Patent Application No. 61/390,317, filed Oct. 6, 2010, which is incorporated herein by reference in its entirety.

### TECHNICAL FIELD

The present disclosure relates to systems and methods for acquiring and exchanging vehicles, and more specifically to systems and methods for acquiring and exchanging vehicles based on a novel unit management method.

### BACKGROUND

Customers are motivated to obtain products from sellers for a variety of reasons. For example, some products are obtained out of necessity, some out of indulgence, and others out of impulse. Each time a customer obtains a particular product, such as a vehicle, from a seller, the buyer and seller must arrange for a mechanism of payment, such as purchasing or financing. However, once the customer completes payment or becomes obligated to complete payment for the vehicle using one of these payment mechanisms, the customer's motivations for obtaining the product may change and the customer may become dissatisfied with the product. For example, customer dissatisfaction may arise because the vehicle is no longer of use to the customer, a different or an additional vehicle is desired, the vehicle has diminished in value, or the vehicle is no longer under warranty. If the customer desires a vehicle product, it will be further dissatisfied because it will be the customer's responsibility to arrange the selling, leasing or trading of the product.

In order to avoid obtaining a vehicle though purchase or financing, a customer may seek a payment mechanism such as leasing. Leasing can allow a customer to obtain a vehicle only for a limited period of time and afford the customer the opportunity to make payments similar to financing, but for the limited period of time. However, as occurs with purchasing and financing, if customer dissatisfaction with the vehicle arises during the lease term, the customer may not be able to obtain a different vehicle.

### SUMMARY

Embodiments a method of vehicle acquisition and exchange are disclosed herein. In one embodiment, the method includes assigning a predetermined number of units for a first vehicle and a predetermined number of units for a second vehicle, providing at least one customer with a customer unit pool representing an amount of available product units and receiving a first request from the at least one customer for the first vehicle. The method also includes determining whether to approve the first request based upon the at least one customer's customer unit pool and the predetermined number of units for the first vehicle using a processor. If the first request is approved, the method also includes receiving a second request from the at least one customer to exchange the first vehicle for the second vehicle and determining whether to approve the second request based upon the at least one customer's customer unit pool and the predetermined number of units for the second vehicle.

Embodiments an apparatus for managing a method of vehicle acquisition and exchange. The apparatus comprises a memory and a processor configured to execute instructions stored in the memory to assign a predetermined number of units for a first vehicle and a predetermined number of units for a second vehicle, provide at least one customer with a customer unit pool representing an amount of available product units and receive a first request from the at least one customer for the first vehicle. The processor is also configured to execute instructions stored in the memory to determine whether to approve the first request based upon the at least one customer's customer unit pool and the predetermined number of units for the first vehicle. If the first request is approved, the processor is also configured to execute instructions stored in the memory to receive a second request from the at least one customer to exchange the first vehicle for the second vehicle and determine whether to approve the second request based upon the at least one customer's customer unit pool and the predetermined number of units for the second vehicle.

These and other embodiments are described in additional detail hereafter.

### BRIEF DESCRIPTION OF THE DRAWINGS

The description herein make reference to the accompanying drawings wherein like reference numerals refer to like parts throughout the several views, and wherein:

FIG. 1 is a pictorial representation of a seller, customer and product management server communication network;

FIG. 2 is a flow diagram illustrating the process by which a customer may enter a unit based vehicle acquisition and exchange system;

FIG. 3 is a pictorial representation of a customer unit pool;

FIG. 4 is a flow diagram illustrating the process by which a product may enter a unit based vehicle acquisition and exchange system; and

FIG. 5 is a flow diagram depicting operation of a unit based vehicle acquisition and exchange system that can be used in the communication network of FIG. 1.

### DETAILED DESCRIPTION

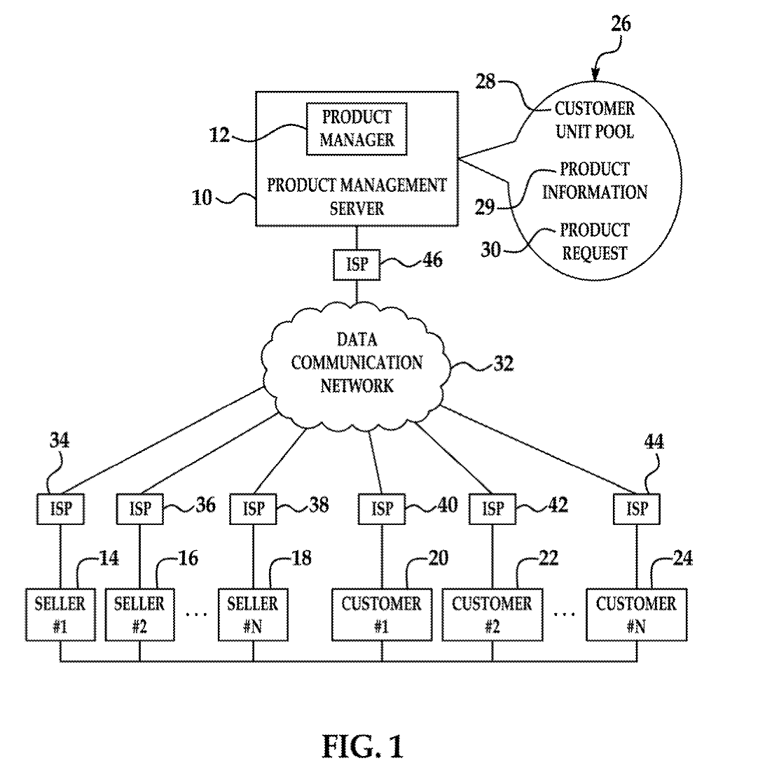

Referring to FIG. 1, a communication network is provided for communication between a product management server 10, a product manager 12, on or more individual sellers 14, 16, 18 and one or more individual customers 20, 22, 24. The communication network can be a computer communication network that allows for sharing of information, data and computing resources.

Product management server 10 provides an access point for data 26, which includes information associated with a customer unit pool 28, product information 29 and a product request 30.

Data 26 is machine readable and is electronically stored in a location accessible to product management server 10. Product management server 10 can be a personal computer, a file server, a data base server, an application server or any electronic computational device or storage medium capable of reading, storing, passing or directing data 26 to or from one or more electronic storage mediums. It is not critical whether data 26 is stored internally or externally of product management server 10. For example, data 26 can be made accessible to product management server 10 by storing it in an internal memory of product management server 10, such as on a hard disk, not shown. Data 26 could alternatively be stored externally from product management server 10 in a location accessible through a separate computer communication network, not shown.

Each individual seller 14, 16, 18 may comprise any entity that desires to provide products to individual customers 20, 22, 24. Similarly, each individual customer 20, 22, 24 may comprise any entity that desires to obtain one or more vehicles from individual sellers 14, 16, 18. Individual sellers 14, 16, 18 and individual customers 20, 22, 24 can be persons, groups of persons, businesses, organizations, government agencies or any combination thereof. Further, a particular entity that may be a seller for the purposes of one transaction may be a customer for the purpose of another transaction, and vice versa.

Each individual seller 14, 16, 18 and each individual customer 20, 22, 24 can communicate with each other and with product management server 10 through a data communication network 32, such as the internet. Individual sellers 14, 16, 18 and individual customers 20, 22, 24 can use the communication network 32 to communicate with each other and to access product management server 10 and data 26 using one or more nodes, not shown. A node can be a desktop or laptop personal computer with a memory, a processor, input and output devices, and a display, not shown. A node could also be a hand held computer such as a personal digital assistant, an mp3 player, a cell phone or any other computational device which can allow an individual seller 14, 16, 18 or individual customer 20, 22, 24 to send and receive information to each other and to product management server 10 over the data communication network 32. In the illustrated configuration, the nodes can be used to access the data communication network 32 through internet service providers (ISPs) 34, 36, 38 and 40, 42, 44. Alternatively, each individual seller 14, 16, 18 can communicate with each individual customer 20, 22, 24 using other techniques such as by telephone, in person or any other form of communication.

Product manager 12 is the logic which controls the operation of the disclosed systems and methods for acquiring and exchanging vehicles. Product manager 12 operates in communication with product management server 10 and takes as an input data 26, which includes information associated with a customer unit pool 28, product information 29 and a product request 30.

A product request 30 for a vehicle (i.e. a product) can originate from individual customers 20, 22, 24. Vehicles include, but are not limited to bicycles, automobiles, trucks, buses, recreational vehicles, ATVs, tractors, industrial equipment, motorcycles and watercraft. In the communication network shown, a product request 30 may be communicated to the product management server 10 by individual customers 20, 22, 24 through a data communication network 32, such as the internet. Product requests could also be communicated first by individual customers 20, 22, 24 to individual sellers 14, 16, 18, through, for example, a data communication network 32, such as the internet, or by telephone, by mail or by direct communication. The individual sellers 14, 16, 18 could then communicate the product request 30 to the product management server 10 through a data communication network 32, such as the internet. Product management server 10 could receive the product request 30 though an internet service provider (ISP) 46 and direct the storage of the information associated with the product request 30 as machine readable data on internal or external memory, or on any other electronic storage medium which can be directed to operate in communication with product management server 10.

Additional information other than data 26 can also optionally be taken as an input into product manager 12. For example, individual sellers 14, 16, 18 could wish to place any number of restrictions on the availability, cost and usage of vehicles. These restrictions could relate to, for example, availability or non-availability of products to certain individual customers 20, 22, 24, responsibility for fees, such as insurance fees or maintenance fees, the amount of time individual customers 20, 22, 24 are permitted to or required to obtain a certain product, or the locations in which a product may be used. In the event that the logic of product manager 12 requires this or any other additional information as an input, it can be first stored on product management server 10, or on any other electronic storage medium which can be directed to operate in communication with product management server 10.

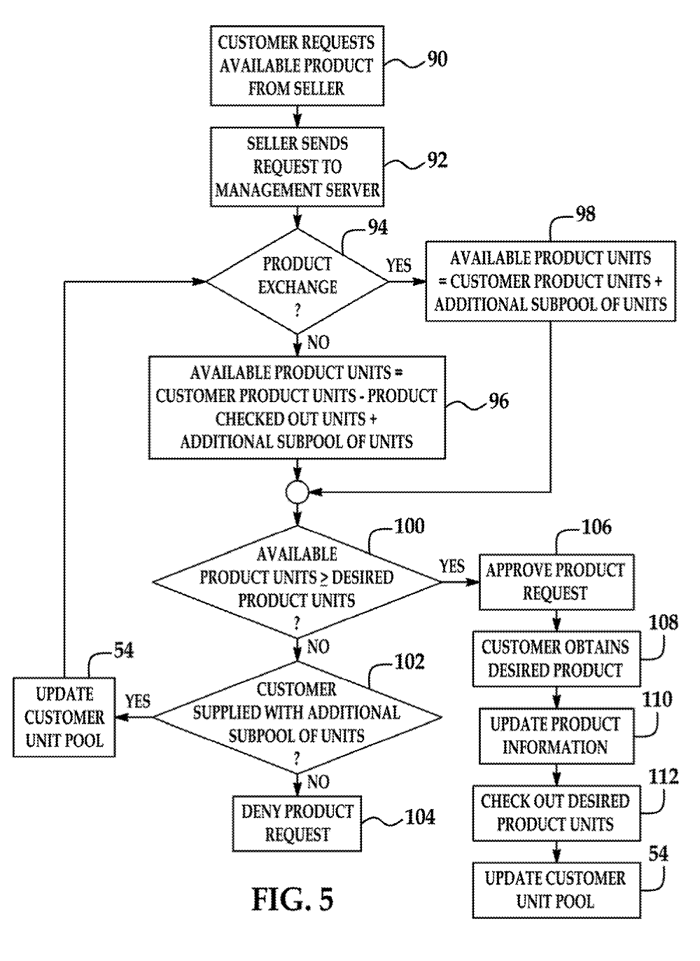

Based upon the inputs received through communication with product management server 10, product manager 12 can determine whether to deny or approve a product request 30. A description of exemplary logic governing this determination is discussed in more detail below with respect to FIG. 5. If a product request 30 is approved and an individual customer 20, 22, 24 obtains the requested product, product manager 12 can track the consequential changes to customer unit pool 28 and product information 29 and can direct product management server 10 to store the updated information associated therewith.

In one embodiment disclosed herein, the logic functions performed by product manager 12 are implemented by one or more computer executable software programs, and product management server 10 can be a computer with internal memory and a processor capable of storing and executing some or all of these computer executable software programs.

Product manager 12 receives inputs through communication with product management server 10. Because the communication network also allows individual sellers 14, 16, 18 and individual customers 20, 22, 24 to communicate with product management server 10, the computer executable software programs implementing the logic functions of product manager 12 may be further distributed and shared among the one or more of the nodes of individual sellers 14, 16, 18 or individual customers 20, 22, 24, or on any other computational device in communication with product management server 10.

Distribution of the computer executable software programs implementing the logic functions of product manager 12 may be desirable, for example, if an individual seller 14, 16, 18 desires to store and execute software on one or more of its nodes in order to make its own determination of whether to deny or approve a product request 30, while preferring to allow software centrally stored on product management server 10 to complete the tasks of updating and storing data 26 after a product request 30 is approved.

The topology of a computer communication network capable of supporting the disclosed systems and methods for acquiring and exchanging products is described by way of example only. Communication of information and data and sharing of computing resources between product management server 10, product manager 12, individual sellers 14, 16, 18 and individual customers 20, 22, 24 can also be achieved, for example, using radio communication, wireless communication, network cables, a peer to peer computer network, a local area network (LAN), a wide area network (WAN) or any combination thereof.

The communication network is described above as being a computer communication network and the logic of product manager 12 can be implemented by one or more computer executable software programs.

Depending upon how the logic of product manager 12 is implemented, it may be desirable for product management server 10, individual sellers 14, 16, 18 and individual customers 20, 22, 24 to share data and information through the computer communication network described above, by telephone, by direct communication or by any suitable combinations thereof.

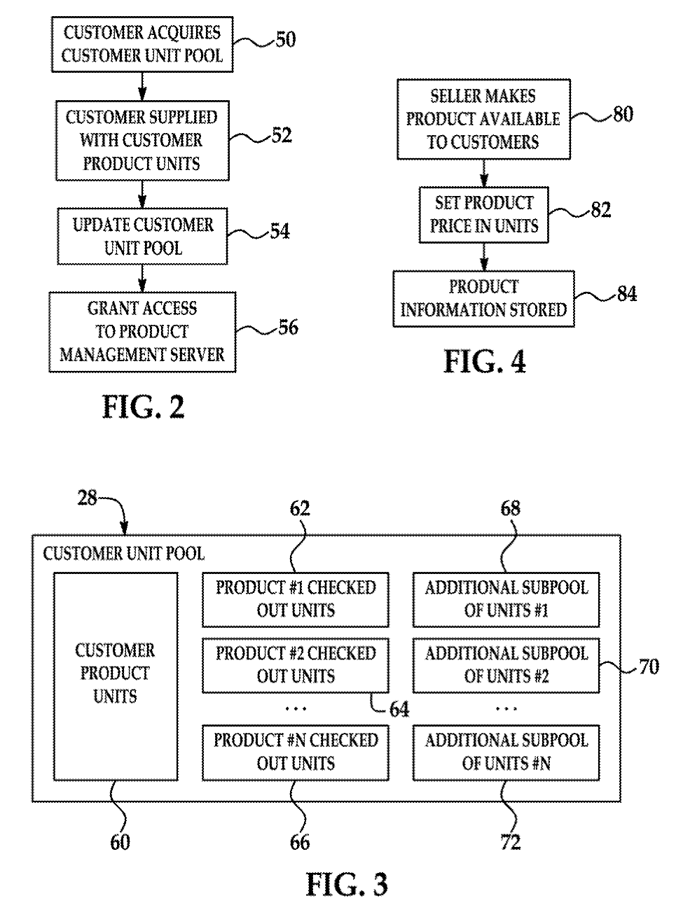

Referring to FIG. 2, a process is illustrated by which individual customers 20, 22, 24 may enter the unit based vehicle acquisition and exchange system.

A characteristic of the unit based vehicle acquisition and exchange system is the concept of a unit, which can be defined in terms of a value per a period of time. The value can be chosen arbitrarily. In some embodiments, the value generally corresponds to the types of products to be provided to individual customers 20, 22, 24 in the unit based vehicle acquisition and exchange system.

Because the vehicle which can be provided in the unit based vehicle acquisition and exchange system can vary, so too can the corresponding value. The value of a vehicle can be a monetary amount, and a unit could be defined as a dollar amount per period of time, such as $100/year.

In step 50, individual customers 20, 22, 24 acquire a customer unit pool 28. Customer unit pool 28 can represent the amount of units that an individual customer 20, 22, 24 has available to obtain products offered by individual sellers 14, 16, 18 in the unit based vehicle acquisition and exchange system for a given period of time. The information associated with customer unit pool 28 can be embodied in a physical medium, such as on paper. The information associated with customer unit pool 28 can alternatively be embodied as machine readable data that can be electronically stored and made accessible to product management server 10, and communicated to individual sellers 14, 16, 18, individual customers 20, 22, 24 and product manager 12 through a computer communication network.

In step 52, and referring now as well to FIG. 3, each individual customer 20, 22, 24 can be supplied with a number of customer product units 60. Customer product units 60 can represent the initial amount of units available to the individual customer 20, 22, 24 for use in the unit based vehicle acquisition and exchange system for a given period of time. In the example given above, where a unit is defined as $100/year, customer product units 60 could be, for example, 5 units for 3 years.

Customer product units 60 can be supplied to an individual customer 20, 22, 24 after the customer product units 60 have been purchased for value. The cost of customer product units 60 can have a direct correspondence to the definition of a unit. Continuing the example given above, an individual customer 20, 22, 24 could purchase 5 units for 3 years at a cost of 5*($100/year)*3 years, or $1500. The cost of customer product units 60 can optionally be adjusted based upon a variety of factors. For example, an individual customer 20, 22, 24 could be charged a premium for the convenience of obtaining products using the unit based vehicle acquisition and exchange system. Or, for example, an individual customer 20, 22, 24 could be given a discount depending upon the total customer product units 60 purchased or on whether there is a promotion running.

However, it is not critical that customer product units 60 be purchased by individual customers 20, 22, 24. For example, customer product units 60 could be supplied to individual customers 20, 22, 24 in exchange for services rendered, gifted to individual customers 20, 22, 24 or supplied to individual customers 20, 22, 24 as a part of an assistance program.

In step 54, product manager 12 updates customer unit pool 28 in response to the individual customer 20, 22, 24 being supplied with customer product units 60, and directs product management server 10 to store the updated information.

In step 56, individual customers 20, 22, 24 are granted access to product management server 10. Because data 26 is available to product management server 10, when an individual customer 20, 22, 24 is granted access to product management server 10, an individual customer 20, 22, 24 can also access data 26 through the communication network of FIG. 1. In one embodiment, where data 26 can be communicated over a computer communication network, individual customers 20, 22, 24 can access data 26 using one or more nodes, view information associated with product information 29 and make a product request 30.

Customer unit pool 28 is depicted in further detail in FIG. 3. In addition to customer product units 60, customer unit pool 28 includes information associated with product checked out units 62, 64, 66 and additional subpools of units 68, 70, 72.

When product manager 12 approves a product request 30, it can permit an individual customer 20, 22, 24 to obtain the requested vehicle. The manner in which an individual customer 20, 22, 24 obtains a vehicle can vary depending upon the nature of the product. For example, an individual customer 20, 22, 24 may obtain the vehicle when it takes physical possession of the vehicle or in any other suitable manner. For example, individual customer 20, 22, 24 can be considered to obtain the vehicle as soon as the request is approved.

Each time an individual customer 20, 22, 24 obtains a vehicle, units can be checked out of the customer unit pool 28 and the overall amount of units available to the individual customer 20, 22, 24 for use in the unit based vehicle acquisition and exchange system is reduced. Taking as an example a first vehicle, product #1 (e.g. a first vehicle) checked out units 62 are checked out of customer unit pool 28 for as long as the first product remains in the possession of the individual customer 20, 22, 24. If the individual customer 20, 22, 24 obtains additional products (e.g. a second vehicle), each product can check out product checked out units 62, 64, 66 for as long as that vehicle remains in the possession of the individual customer 20, 22, 24. Additionally, or alternatively, the individual customer 20, 22, 24 can exchange the additional desired product for product #1 as will be discussed in more detail below.

As described in greater detail below, once a customer has obtained one or more vehicles, product manager 12 takes into account product checked out units 62, 64, 66 when determining whether to approve or deny a product request 30.

In addition to being supplied with product customer units 60, the unit based vehicle acquisition and exchange system allows for an individual customer 20, 22, 24 to be supplied with additional subpools of units 68, 70, 72. Like customer product units 60, additional subpools of units 68, 70, 72 represent amounts of units available to the individual customer 20, 22, 24 for use in the unit based vehicle acquisition and exchange system for a given period of time.

Although it is not critical, additional subpools of units 68, 70, 72 can generally be supplied to an individual customer 20, 22, 24 on the same basis as customer product units 60 were supplied to the individual customer 20, 22, 24. For example, both customer product units 60 and additional subpools of units 68, 70, 72 are supplied to individual customers 20, 22, 24 after they have been purchased for value. Alternatively, both customer product units 60 and additional subpools of units 68, 70, 72 could be supplied to individual customers 20, 22, 24 in exchange for services rendered, gifted to individual customers 20, 22, 24 or supplied to individual customers 20, 22, 24 as a part of an assistance program.

An individual customer 20, 22, 24 may desire to be supplied with additional subpools of units 68, 70, 72 for a variety of reasons. For example, if product management server 12 denies a product request 30 for a first product because an individual customer 20, 22, 24 does not have an adequate amount of customer product units 60 to the first product, the individual customer 20, 22, 24 may need to be supplied with additional subpools of units 68, 70, 72 before product manager 12 will approve the product request 30.

Further, for example, if the product request 30 for the first product is approved, an individual customer 20, 22, 24 may later desire to obtain a second product. If, taking into account product #1 checked out units 62, the individual customer 20, 22, 24 does not have an adequate amount of customer product units 60 to obtain the second product, the individual customer 20, 22, 24 may need to be supplied with additional subpools of units 68, 70, 72 before product manager 12 will approve the product request 30 for the second product.

FIG. 4 is a flow diagram illustrating the process by which a vehicle may enter the unit based vehicle acquisition and exchange system. The process described below can be repeated for each vehicle that enters the unit based vehicle acquisition and exchange system.

In step 80, an individual seller 14, 16, 18 makes its vehicles available to individual customers 20, 22, 24. An individual seller 14, 16, 18 makes a particular product available to individual customers 20, 22, 24 when the individual seller 14, 16, 18 generally agrees to allow an individual customer 20, 22, 24 to obtain the particular product, utilizing the unit based payment mechanism provided for in the disclosed unit based vehicle acquisition and exchange system, pending approval of a product request 30 for the particular product by product manager 12.

In step 82, the price of the vehicle made available in step 80 is set in units. As explained above, a unit can be defined in terms of a value per a period of time, and the value can correspond to the types of products to be provided to individual customers 20, 22, 24 in the unit based vehicle acquisition and exchange system. For example, the value can be a monetary amount, and a unit could be defined as a dollar amount per period of time, such as $100/year.

The price of an available vehicle may be set by an entity, including individual sellers 14, 16, 18, individual customers 20, 22, 24, product manager 12, an independent third party or by any combination of these.

For example, the price of an available vehicle can be set by an individual seller 14, 16, 18 to correspond to the price at which an individual seller 14, 16, 18 is willing to offer the product to an individual customer 20, 22, 24. If a unit is defined as $100/year, and if an individual seller 14, 16, 18 would be willing to allow an individual customer 20, 22, 24 to obtain the product for $250 per year, the price of the product could be set at 2.5 units.

By further example, an individual customer 20, 22, 24 may propose a price for a available product to an individual seller 14, 16, 18 corresponding to the amount of units to be checked out of customer unit pool 28 if the individual customer 20, 22, 24 obtains the product, and the price of the product in units could be set through a negotiation process between an individual seller 14, 16, 18 and an individual customer 20, 22, 24.

By further example, the price for an available product can be determined by product manager 12. This determination could be made based upon a variety of factors. For example, for a consumer product, relevant market related factors may include cost of the product, condition of the product, age of the product, likely depreciation of the product and demand for the product, and relevant non-market related factors may include preferences for certain individual customers 20, 22, 24 or price suggestions from individual sellers 14, 16, 18 or individual customers 20, 22, 24.

The process described above can generally repeated for each vehicle that enters the unit based vehicle acquisition and exchange system. Because the unit based vehicle acquisition and exchange system may include any number of individual sellers 14, 16, 18, each with its own preferences with respect to how the price of available products is set, there can be variation in the precise process by which the price is set for each available product. For example, individual seller #1 14 may wish to set the prices for the available vehicles it offers without the input of individual customer 20, 22, 24 or product manager 12, while individual seller #2 16 may allow for negotiation of the prices of the available vehicles it offers. Further, for example, individual customer #N 18 may wish to independently set the prices for some of the available vehicles it offers, while allowing for negotiation of the prices of other available vehicles and allowing the prices of yet other available products to be set by product manager 12.

In step 84, once the price of an available vehicle is set, product manager 12 directs product management server 10 to store the information associated with the price of the available product as product information 29.

FIG. 5 is a flow diagram depicting the operation of product manager 12 in the unit based vehicle acquisition and exchange system.

In step 90, an individual customer 20, 22, 24 can communicate a product request 30 to an individual seller 14, 16, 18. As explained in greater detail above, product request 30 can be sent to the individual seller 14, 16, 18 through the communication network of FIG. 1.

A product request 30 includes information associated with the particular available product or products that the individual customer 20, 22, 24 desires to obtain from one or more individual sellers 14, 16, 18 and information associated with whether the individual customer 20, 22, 24 desires to obtain the available product or products as a part of a product acquisition or as part of a product exchange. A product request 30 may also include information associated with the length of time that the individual customer 20, 22, 24 desires to obtain the available vehicle(s).

For explanatory purposes, the particular available vehicle(s) requested in a product request 30 are referred to as a desired product, which has a price set in desired product units.

In step 92, the individual seller 14, 16, 18 communicates the product request 30 to the product management server 10 through the communication network of FIG. 1.

The communication of a product request 30, first from an individual customer 20, 22, 24 to an individual seller 14, 16, 18, and then from the individual seller 14, 16, 18 to product management server 10 is depicted in FIG. 5 as taking place in two separate steps 90 and 92. As explained above, an individual seller 14, 16, 18 may wish to place any number of restrictions on the availability, cost and usage of products offered to individual customers 20, 22, 24. Therefore, a product request 30 can be first directed to an individual seller 14, 16, 18 to facilitate initial screening and approval by the individual seller 14, 16, 18. However, it should be understood that a product request 30 could also be communicated from an individual customer 20, 22, 24 to the product management server 10. For example, an individual customer 20, 22, 24 could be screened and approved before being allowed to participate in the unit based vehicle acquisition and exchange system. In this example, the individual sellers 14, 16, 18 would not be required to screen and approve a product request 30, and the product request 30 could be communicated from the individual customer 20, 22, 24 to the product management server 10.

In step 94, product manager 12 evaluates product request 30 to determine whether the individual customer 20, 22, 24 is requesting to exchange the desired product or products for one or more products which have already been obtained, or whether the individual customer 20, 22, 24 is requesting to acquire the desired product or products in addition to one or more products that the individual customer 20, 22, 24 has already obtained and desires to continue to obtain.

For example, an individual customer 20, 22, 24 may have previously obtained a first product. If the individual customer 20, 22, 24 requests to exchange the first product for the desired product or products, product manager 12 can treat the product request 30 as a request for a product exchange. If, however, the individual customer 20, 22, 24 requests to obtain the desired product or products in addition to and simultaneously with the first product, product manager 12 can treat product request 30 as a request for a product acquisition. Product manager 12 can also treat product request 30 as a request for a product acquisition if it is the first product request 30 from the particular individual customer 20, 22, 24.

In steps 96 and 98, product manager 12 determines the amount of available product units in the customer unit pool 28 of the individual customer 20, 22, 24 that requested the desired product. The amount of available product units represents the amount of units currently available in the customer unit pool 28 of the individual customer 20, 22, 24 that can be utilized to obtain the desired product.

As described above, customer product units 60 represents an amount of units available to an individual customer 20, 22, 24 for use in the unit based vehicle acquisition and exchange system for a given period of time. An individual customer 20, 22, 24 may only make a product request 30 during the period of time provided for in the initial supply of customer product units 60. For example, if an individual customer 20, 22, 24 has been supplied with customer product units 60 in the amount of 5 units for 3 years, there is a 3 year window in which the 5 units may be utilized in the vehicle acquisition and exchange system. To the extent that an individual customer 20, 22, 24 does not make one or more product requests 30, does not obtain one or more products or otherwise underutilizes customer product units 60 within this time period, customer product units 60 may be surrendered.

However, an individual customer 20, 22, 24 may be allowed more flexibility in utilizing additional subpools of units 68, 70, 72. As described above, additional subpools of units 68, 70, 72, like customer product units 60, represent an amount of units available to the individual customer 20 for use in the unit based vehicle acquisition and exchange system for a given period of time. The period of time given in additional subpools of units 68, 70, 72 can be any period of time less than or equal to the period of time given in customer product units 60, and an individual customer 20, 22, 24 can utilize additional subpools of units 68, 70, 72 at any time within the period of time provided for in the initial supply of customer product units 60.

Taking again the example in which an individual customer 20, 22, 24 has been supplied with customer product units 60 in the amount of 5 units for 3 years, the individual customer 20, 22, 24 may desire to be supplied with one or more additional subpools of units 68, 70, 72.

If the individual customer 20, 22, 24 desires to utilize more than 5 units in the vehicle acquisition and exchange system continuously throughout the period of 3 years given in product customer units 60, it may be supplied with an additional subpool of units 68 in the amount of, for example, 1 unit for 3 years. Together with customer product units 60, the individual customer 20, 22, 24 would have units available in an amount of 6 units for 3 years.

In this example, because additional subpool of units 68 are utilized within the period of time given in the initial supply of customer product units 60, and because the amount of time given in customer product units 60 and the amount of time given in additional subpool of units 68 are the same, the individual customer 20, 22, 24 is limited in the utilization of additional subpool of units 68. In practical effect, the individual customer 20, 22, 24 is limited in the same manner as if the individual customer 20, 22, 24 had been initially supplied with customer product units 60 in the amount of 6 units for 3 years.

If, however, an individual customer 20, 22, 24 is supplied with an additional subpool of units 70 with a given period of time less than the amount of time given in customer product units 60, the individual customer 20, 22, 24 is allowed more flexibility in the utilization of additional subpool of units 70 in the vehicle acquisition and exchange system.

For example, an individual customer may be supplied with an additional subpool of units 70 in the amount of, for example, 3 units for 1 year. Additional subpool of units 70 can be utilized within the period of time given in the initial supply of customer product units 60. Continuing the example above where an individual customer 20, 22, 24 has been supplied with customer product units 60 in the amount of 5 units for 3 years, the individual customer 20, 22, 24 can choose any 1 year period within the 3 year period given in customer product units 60 to utilize additional subpool of units 70. During the chosen 1 year period, the individual customer 20, 22, 24 would have units available in an amount of 8 units.

An individual customer 20, 22, 24 can be supplied with any number of additional subpools of units 68, 70, 72, and additional subpools of units 68, 70, 72 can be used simultaneously with each other in the vehicle acquisition and exchange system. Continuing the example above where an individual customer 20, 22, 24 has been supplied with customer product units 60 in the amount of 5 units for 3 years and an additional subpool of units 70 in the amount of 3 units for 1 year, the individual customer 20, 22, 24 could be further supplied with an additional subpool of units 72 in the amount of, for example, 5 units for 2 days. The individual customer 20, 22, 24 can choose any 2 day period within the 3 year period given in customer product units 60 to utilize additional subpool of units 72. If the 2 day period chosen to utilize additional subpool of units 72 coincides with the chosen 1 year period to utilize additional subpool of units 70, the individual customer 20, 22, 24 would have units available in an amount of 13 units during the chosen 2 day period.

Additional subpools of units 68, 70, 72 can be utilized within the period of time given in the initial supply of customer product units 60, and to the extent that an individual customer 20, 22, 24 underutilizes additional subpools of units 68, 70, 72 within this time period, additional subpools of units 68, 70, 72 may be surrendered. If an individual customer 20, 22, 24 desires to be supplied with units that can be utilized in the unit based vehicle acquisition and exchange system beyond the period of time given in the initial supply of customer product units 60, the individual customer 20, 22, 24 can acquire a second customer unit pool 28 with a second supply of customer product units 60.

For explanatory purposes, each product request 30 can be made during the period of time provided for in the initial supply of customer product units 60. However, in other embodiments, a product request 30 can be made at another suitable time period.

In step 94, product manager 12 evaluates product request 30 to determine whether the individual customer 20, 22, 24 has requested to exchange the desired product for one or more products which have been obtained, or whether the individual customer 20, 22, 24 has requested to acquire the desired product in addition to one or more products that the individual customer 20, 22, 24 has obtained and desires to continue to obtain.

In step 96, if product manager 12 determines in step 94 that product request 30 is a request for a product acquisition, product manager 12 determines the amount of available product units in the customer unit pool 28 of the individual customer 20, 22, 24 that requested the desired product.

To determine the amount of available product units, the product manager 12 can first subtract any amount of product checked out units 62, 64, 66 from customer product units 60. Taking again the example in which an individual customer 20, 22, 24 has been supplied with customer product units 60 in the amount of 5 units for 3 years, customer product units 60 is 5 units. If the individual customer 20, 22, 24 has not previously obtained a product, or if any previously obtained products have been returned, there may be no product checked out units 62, 64, 66 and customer product units 60 subtracted by product checked out units 62, 64, 66 will be 5 units.

If, however, the individual customer 20, 22, 24 has previously obtained a first product, and continues to obtain the first product at the time of product request 30, customer unit pool 28 can include product checked out units 62 in the amount of the price of product #1. If, for example, the price of product #1 is 1.5 units, then product checked out units 62 will be 1.5 units and customer product units 60 subtracted by product checked out units 62, 64, 66 will be 3.5 units.

Product manager 12 can next add any amount of additional subpools of units 68, 70, 72. Product manager 12 may evaluate information associated with the length of time that the individual customer 20, 22, 24 desires to obtain a desired product, and add any additional subpools of units 68, 70, 72 only if the length of time that the individual customer 20, 22, 24 desires to obtain the desired product is less than the period of time given in the additional subpool of units 68, 70, 72. For example, an individual customer 20, 22, 24 with an additional subpool of units 70 in the amount of 3 units for 1 year and an additional subpool of units 72 in the amount of 5 units for 2 days could request to obtain a desired product for 6 months. In this example, the 3 units of additional subpool of units 70 would be available to the individual customer 20, 22, 24 to obtain the desired product for 6 months, and 3 units could be included in the amount of available product units. However, the 5 units of additional subpool of units 72 would not be available to the individual customer 20, 22, 24 to obtain the desired product for 6 months, and those 5 units would not be included in the amount of available product units.

In step 98, if product manager 12 determines in step 94 that product request 30 is a request for a product exchange, product manager 12 determines the amount of available product units in the customer unit pool 28 of the individual customer 20, 22, 24 that requested the desired product. The determination of the amount of available product units is the same as in step 96, except that in step 98 product manager 12 does not first subtract any amount of product checked out units 62, 64, 66 from customer product units 60 with respect to any product or products that the individual customer 20, 22, 24 desires to exchange for the desired product.

In step 100, product manager 12 determines whether the amount of available product units determined in step 96 or in step 98 is greater than or equal to the price set for the desired product.

If product manager 12 determines in step 100 that the amount of available product units determined in step 96 or in step 98 is not greater than or equal to the price set for the desired product, an individual customer 20, 22, 24 may desire to be supplied with one or more additional subpools of units 68, 70, 72 in order to increase the available product units in customer unit pool 28. In step 102, product manager 12 determines whether the individual customer 20, 22, 24 has been supplied with one or more additional subpools of units 68, 70, 72.

If the individual customer 20, 22, 24 has been supplied with one or more additional subpools of units 68, 70, 72, product manager 12 in step 54 updates customer unit pool 28 in response to the individual customer 20, 22, 24 being supplied with additional subpools of units 68, 70, 72 and directs product management server 10 to store the updated information. Product manager 12 then proceeds to step 94. If the individual customer 20, 22, 24 has not been supplied with one or more additional subpools of units 68, 70, 72, product manager 12 denies the product request 30 in step 104 and the individual customer 20, 22, 24 is not permitted to obtain the desired product.

If product manager 12 determines in step 100 that the amount of available product units determined in step 96 or in step 98 is greater than or equal to the price set for the desired product, product manager 12 approves the product request 30 in step 106 and the individual customer 20, 22, 24 is permitted to obtain the desired product in step 108.

In step 110, product manager 12 updates product information 29 of the desired product to reflect that the desired product has been obtained by a particular individual customer 20, 22, 24 and may no longer be available to other individual customers 20, 22, 24 in the unit based acquisition and exchange system. Product manager 12 also directs product management server 10 to store the updated product information 29.

In step 112, in response to the individual customer 20, 22, 24 obtaining the desired product in step 108, the desired product becomes a checked out product and product checked out units 62, 64, 66 are checked out of customer unit pool 28 in an amount corresponding to the price of the desired product. In step 54, product manager 12 updates customer unit pool 28 to reflect the change in product checked out units 62, 64, 66 and directs product management server 10 to store the updated information.

The above described embodiment, where an individual customer 20, 22, 24 utilizes customer product units 60 and additional subpools of units 68, 70, 72 during the period of time given in the initial supply of customer product units 60, has been described in considerable detail. The embodiments of the vehicle acquisition and exchange system have many advantages, including ease of administration of the vehicle acquisition and exchange system and predictable and constant levels of utilization of customer unit pool 28 during the period of time given in customer product units 60.

There are many possible variations on the manner in which product manager 12 can allow an individual customer 20, 22, 24 to utilize a customer unit pool 28 and there are many possible variations on the manner in which product manager 12 can determine the amount of available product units in a customer unit pool 28. For example, in one variation, customer unit pool 28 can include one time use units, wherein product checked out units 62, 64, 66 are taken out of customer unit pool 28 each time a product is obtained.

In another variation, the only restriction that product manager 12 could place on the utilization of a customer unit pool 28 by an individual customer 20, 22, 24 could correspond to the aggregate worth of the customer unit pool 28 in relation to the price of a desired product and the length of time that the individual customer 20, 22, 24 desires to obtain the desired product.

Customer product units 60 and additional subpools of units 68, 70, 72 can represent amounts of units available to an individual customer 20, 22, 24 for use in the unit based vehicle acquisition and exchange system for given periods of time, and can be described as corresponding to a unit*period of time.

The aggregate worth of a customer unit pool 28 could be determined by first multiplying the amount of units of each of customer product units 60 and additional subpools of units 68, 70, 72 by the respective given periods of time. For example, if an individual customer 20, 22, 24 has been supplied with customer product units 60 in the amount of 5 units for 3 years, and has been supplied with an additional subpool of units 70 in the amount of 3 units for 1 year, the aggregate worth of the customer unit pool 28 would be 5 units*3 years plus 3 units*lyear, or 18 units*year.

Product checked out units 62, 64, 66 can also be described as corresponding to a unit*period of time. Each product obtained by an individual customer 20, 22, 24 will check out product checked out units 62, 64, 66 for as long as that product remains in the possession of the individual customer 20, 22, 24. If, for example, the price of product #1 is 1.5 units, and product #1 is checked out for 2 years, product checked out units 62 will be 1.5 units*2 years, or 3 units*year.

In this example, the aggregate worth of the customer unit pool 28 is 15 units*year, and a product request 30 could be approved in step 100 and step 106 if the price of a desired product multiplied by the length of time that the individual customer 20, 22, 24 desires to obtain the desired product is less than or equal to 15 units*year.

The embodiments of the product management server 12 and the nodes associated with individual sellers 14, 16, 18 and individual customer 20, 22, 24 (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination.

Further, in one embodiment, for example, the product manager 12, and the nodes associated with individual sellers 14, 16, 18 and individual customer 20, 22, 24 can be implemented using a general purpose computer/processor with a computer program that, when executed, carries out any of the respective methods, algorithms and/or instructions described herein. In addition or alternatively, for example, a special purpose computer/processor can be utilized which can contain specialized hardware for carrying out any of the methods, algorithms, or instructions described herein.

Further, all or a portion of embodiments can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method of vehicle acquisition and exchange, comprising:
assigning a predetermined number of units for a first vehicle and a predetermined number of units for a second vehicle;
providing at least one customer with a customer unit pool representing an amount of available product units;
receiving a first request from the at least one customer for the first vehicle;
determining whether to approve the first request based upon the at least one customer's customer unit pool and the predetermined number of units for the first vehicle using a processor; and
if the first request is approved:
receiving a second request from the at least one customer to exchange the first vehicle for the second vehicle; and
determining whether to approve the second request based upon the at least one customer's customer unit pool and the predetermined number of units for the second vehicle.

2. The method of claim 1, further comprising:
if the first request is approved:
updating the at least one customer's customer unit pool based upon the predetermined number of units for the first vehicle; and
determining whether to approve the second request based upon the at least one customer's updated customer unit pool and the predetermined number of units for the second vehicle.

3. The method of claim 1 wherein a unit represents a monetary value per a period of time, further comprising:
approving the second request if the amount of available product units is greater than or equal to the predetermined number of units for the second vehicle; and
denying the second request if the amount of available product units is less than the predetermined number of units for the second vehicle.

4. The method of claim 3, wherein the at least one customer's customer unit pool includes customer product units and additional units, each representing an amount of units for a predetermined period of time.

5. The method of claim 4, further comprising:
providing the at least one customer's customer unit pool with the customer product units at a first time; and
including customer product units in the amount of available product units if the request for the second vehicle is received between the first time and the predetermined period of time represented by the customer product units.

6. The method of claim 4, further comprising:
providing the at least one customer's customer unit pool with the additional units at a second time; and
including additional units in the amount of available product units if the request for the second vehicle is received between the second time and the predetermined period of time represented by the additional units.

7. The method of claim 4, wherein the second request includes information associated with a requested period of time to possess the second vehicle.

8. The method of claim 7, wherein:
customer product units are included in the amount of available product units if the predetermined period of time represented by the customer product units is equal to or greater than the requested period of time to possess the second vehicle; and
additional units are included in the amount of available product units if the predetermined period of time represented by the additional units is equal to or greater than the requested period of time to possess the second vehicle.

9. The method of claim 2, wherein the at least one customer's updated customer unit pool includes checked out units representing the predetermined number of units for the first vehicle.

10. The method of claim 1, wherein the first and second requests are received from a customer via a network.

11. An apparatus for managing a method of vehicle acquisition and exchange, comprising:
a memory; and
a processor configured to execute instructions stored in the memory to:
assigning a predetermined number of units for a first vehicle and a predetermined number of units for a second vehicle;
provide at least one customer with a customer unit pool representing an amount of available product units;
receive a first request from the at least one customer for the first vehicle;
determine whether to approve the first request based upon the at least one customer's customer unit pool and the predetermined number of units for the first vehicle; and
if the first request is approved:
receive a second request from the at least one customer to exchange the first vehicle for the second vehicle; and
determine whether to approve the second request based upon the at least one customer's customer unit pool and the predetermined number of units for the second vehicle.

12. The apparatus of claim 11, wherein the processor is further configured to:
if the first request is approved:
receive a second request from the at least one customer for the second vehicle;
update the at least one customer's customer unit pool based upon the predetermined number of units for the first vehicle; and
determine whether to approve the second request based upon the at least one customer's updated customer unit pool and the predetermined number of units for the second vehicle.

13. The apparatus of claim 11 wherein a unit represents a monetary value per a period of time and wherein the processor is further configured to:
approve the second request if the amount of available product units is greater than or equal to the predetermined number of units for the second vehicle; and
deny the second request if the amount of available product units is less than the predetermined number of units for the second vehicle.

14. The apparatus of claim 13, wherein the at least one customer's customer unit pool includes customer product units and additional units, each representing an amount of units for a predetermined period of time.

15. The apparatus of claim 14, wherein the processor is further configured to:
provide the at least one customer's customer unit pool with customer product units at a first time; and
include customer product units in the amount of available product units if the request for the second vehicle is received between the first time and the predetermined period of time represented by the customer product units.

16. The apparatus of claim 14, wherein the processor is further configured to:
supply the at least one customer's customer unit pool with additional units at a second time; and
include additional units in the amount of available product units if the request for the second vehicle is received between the second time and the predetermined period of time represented by the additional units.

17. The apparatus of claim 14, wherein the second request includes information associated with a requested period of time to possess the second vehicle.

18. The apparatus of claim 17, t wherein the processor is further configured to:
include customer product units in the amount of available product units if the predetermined period of time represented by the customer product units is equal to or greater than the requested period of time to possess the second vehicle; and
include additional units in the amount of available product units if the predetermined period of time represented by the additional units is equal to or greater than the requested period of time to possess the second vehicle.

19. The apparatus of claim 12, wherein the at least one customer's updated customer unit pool includes checked out units representing the predetermined number of units for the first vehicle.

20. The apparatus of claim 11, wherein the apparatus receives the first and second requests from a customer via a network.
